(19) United States
(12) Patent Application Publication
(10) Pub. No.: US 2012/0105924 A1
(43) Pub. Date: May 3, 2012

(54) SELF-CLEANING DOCUMENT HANDLER WITH VIBRATING CLEANER ELEMENTS

(75) Inventors: Gareth Andrew Dobinson, Hertfordshire (GB); Nicholas Baxter, Hertfordshire (GB); Alexandria Jayne Dobinson, Hertfordshire (GB); Lewis Williams, Barry (GB)

(73) Assignee: XEROX CORPORATION, NORWALK, CT (US)

(21) Appl. No.: 12/938,566

(22) Filed: Nov. 3, 2010

(51) Int. Cl. H04N 1/04

(52) U.S. Cl. 358/498

(57) ABSTRACT

Scanning devices include a sheet feeder moving sheets of media. A transparent scanning surface (e.g., platen) is positioned adjacent the sheet feeder. The sheet feeder supplies the sheets of media to the transparent scanning surface and moves the sheets of media across the transparent scanning surface. Additionally, an optical scanner is positioned adjacent the transparent scanning surface. The optical scanner detects contrasting markings on the sheets of media through the transparent scanning surface. Vibrating elements are connected to the transparent scanning surface.

### BACKGROUND

Embodiments herein generally relate to scanning devices and more particularly to a scanning device that includes vibrating elements that provide a self-cleaning function.

Many modern devices use optical scanners. For example, scanning devices are used to scan images appearing on sheets of media (such as paper, card stock, slides, etc.). These optical scanners usually determine (on a pixel by pixel basis) the lightness and darkness (and potentially color) of a certain location of the sheet being scanned. For example, if black markings are printed on a white sheet of paper, the optical scanner can differentiate printed portions from non-printed portions based upon the contrasting amount of the light being reflected from the sheet of paper. This information is then processed by a computerized processor and can be stored, transmitted to another computerized device, printed, subjected to data acquisition through, for example, optical character recognition (OCR) processes, etc.

To prevent the optical sensors from being damaged and to extend the life of the scanning device, the optical sensors are generally separated from the medium being scanned by some transparent surface, such as a glass layer. Modern document handler scanning devices often include a large transparent surface (that is sometimes referred to as a main platen) to allow the users to scan large items (such as books, newspapers, etc.). A movable optical scanning bar can be moved beneath the main platen to optically scan such large items. Additionally, document handler scanning devices also scan sheets of media as they are moved past the optical scanner bar. The transparent surface that is positioned adjacent to the stationary optical scanner bar is often called a secondary platen or constant velocity transport (CVT) glass, and the secondary platen is generally much smaller than the main platen.

However, contamination on the platen can interfere with the ability of the optical sensors to properly detect what appears on the sheet of media being scanned. While it is a fairly easy task to remove contaminants from one side of the platen (the top side of the platen that is on the exterior of the scanning device and is easily accessed by the user) it is more difficult to remove contaminants from the bottom or underside of the platen (as the underside surface faces the internal region of the scanning device). In order to remove contaminants from the underside of the platen, the scanning device often needs to be partially disassembled so that access can be had to the internal region of the scanning device.

One exemplary scanning device is known as a constant velocity transport (CVT) scanner, which is very useful for sheets that contain printing on both sides (duplex printed sheets). A CVT scanner includes various media paths that allow one side of the media to be passed by a stationary optical scanner, and for the media to be automatically flipped over so that the opposite side of the sheet of media can be passed by the optical scanner (without requiring the user to manually flip the sheet of media over). However, with such CVT scanning devices, it is very difficult to access the underside of the transparent surface (platen or glass).

If dirt or dust is present on the transparent surface at the imaging point, this produces a continuous line through the image. If the contamination is on the upper side of the glass it is easily fixed by wiping, but contamination on the underside can only be fixed by a service call. Contamination on the underside of the glass is very frustrating as it spoils every image captured by the optical scanner.

### SUMMARY

One exemplary embodiment herein comprises any form of scanning device, such as one used within a document handler of a printing device. The scanning device includes a sheet feeder moving sheets of media. A transparent scanning surface (e.g., platen) is positioned adjacent the sheet feeder. The sheet feeder supplies the sheets of media to the transparent scanning surface and moves the sheets of media across the transparent scanning surface.

Additionally, an optical scanner is positioned adjacent the transparent scanning surface. The optical scanner detects contrasting markings on the sheets of media through the transparent scanning surface. Vibrating elements (e.g., electro-mechanical elements, piezoelectric elements, etc.) are connected to the transparent scanning surface. Such elements vibrate the transparent scanning surface which dislodges the particles of contamination, thereby self-cleaning the transparent scanning surface.

A controller is operatively connected to the optical scanner and the vibrating elements. In some embodiments the controller can cause the vibrating elements to vibrate after a predetermined number of sheets have passed over the transparent scanning surface, when the controller determines that the transparent scanning surface is contaminated with debris (based on the number of sheets processed since the last cleaning, the quality of images obtained by the optical scanner, upon user request, etc.).

The vibrating elements can vibrate at frequencies that affect debris particles on the transparent scanning surface and thereby move debris particles from the transparent scanning surface. The vibrating elements can alternatively vibrate at frequencies that cause pressure waves that move air particles over the transparent scanning surface.

Various method embodiments herein move sheets of media using a sheet feeder of a scanning device. The sheet feeder moves the sheets of media across a transparent scanning surface of the scanning device. The method embodiments herein detect contrasting markings on the sheets of media through the transparent scanning surface using an optical scanner of the scanning device. In addition, the method embodiments herein vibrate elements connected to the transparent scanning surface, under the direction of a controller. The controller can, for example, cause the elements to vibrate after a predetermined number of sheets have passed over the transparent scanning surface, or when the controller determines the transparent scanning surface is contaminated with debris (based on the quality of images obtained by the optical scanner, upon user request, etc.).

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a side-view schematic diagram of a device according to embodiments herein;

FIG. 2 is a perspective-view schematic diagram of a device according to embodiments herein;

FIG. 3 is a side-view schematic diagram of a device according to embodiments herein;

FIG. 4 is a perspective-view schematic diagram of a device according to embodiments herein; and

FIG. 5 is a flow diagram illustrating various embodiments herein.

### DETAILED DESCRIPTION

As mentioned above, contamination on the underside of the transparent scanning surface is a problem that can occur on any scanner. Dirt or dust present on the transparent scanning surface at the imaging point manifests itself as a continuous line through the image, which is very frustrating as it spoils every image captured by the scanner.

In order to address this situation, the embodiments herein add vibrating elements (such as electro-mechanical vibration elements, piezoelectric elements, etc.) to the transparent scanning surface. Such vibrating elements are activated to cause particles of contamination to vibrate off the transparent scanning surface. The vibrating elements can be placed on the larger main platen or on the smaller secondary platen (CVT glass). As would be understood by those ordinarily skilled in the art, relatively smaller (and/or potentially fewer) vibrating elements would be needed to be attached to the relatively smaller secondary platen (compared to the larger main platen).

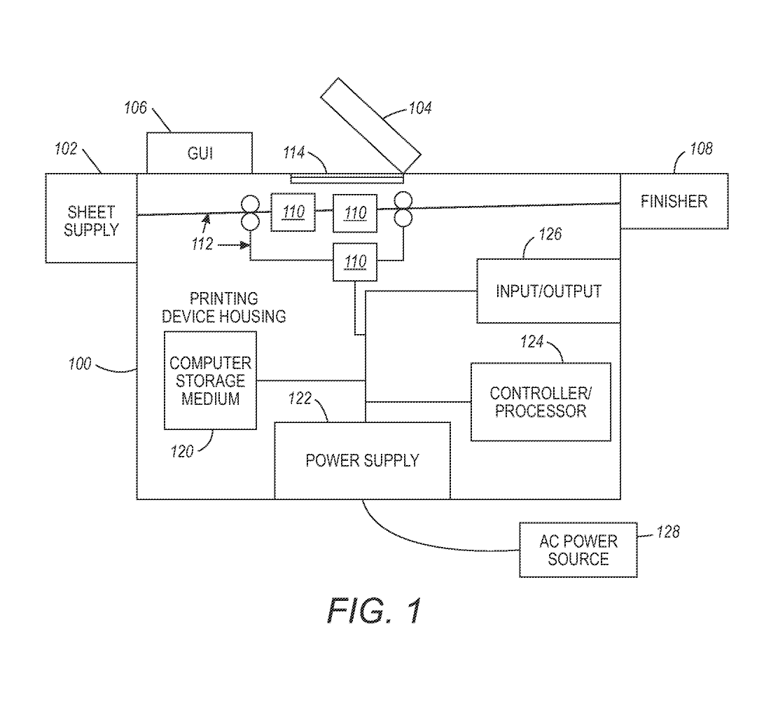

Therefore, the embodiments herein provide any form of scanning device, such as one used within a document handler 104 of a printing device 100, as illustrated schematically in FIG. 1. The printing device 100 can comprise, for example, a printer, copier, multi-function machine, etc. The printer body housing 100 has one or more functional components that operate on power supplied from the alternating current (AC) 128 by the power supply 122. The power supply 122 converts the external power 128 into the type of power needed by the various components.

The printing device 100 includes a controller/processor 124, at least one marking device (printing engine) 110 operatively connected to the processor 124, a media path 112 positioned to supply sheets of media from a paper tray 102 to the marking device(s) 110 and a communications port (input/output) 126 operatively connected to the processor 124 and to a computerized network external to the printing device. After receiving various markings from the printing engine(s), the sheets of media pass to a finisher 108 which can fold, staple, sort, etc., the various printed sheets.

Further, the printing device 100 includes at least one accessory functional component, such as the sheet supply/paper tray 102, finisher 108, graphic user interface assembly 106, etc., that also operate on the power supplied from the external power source 128 (through the power supply 122).

The processor 124 controls the various actions of the printing device. A computer storage medium 120 (which can be optical, magnetic, capacitor based, etc.) is readable by the processor 124 and stores the scanned images and instructions that the processor 124 executes to allow the multi-function printing device to perform its various functions, such as those described herein.

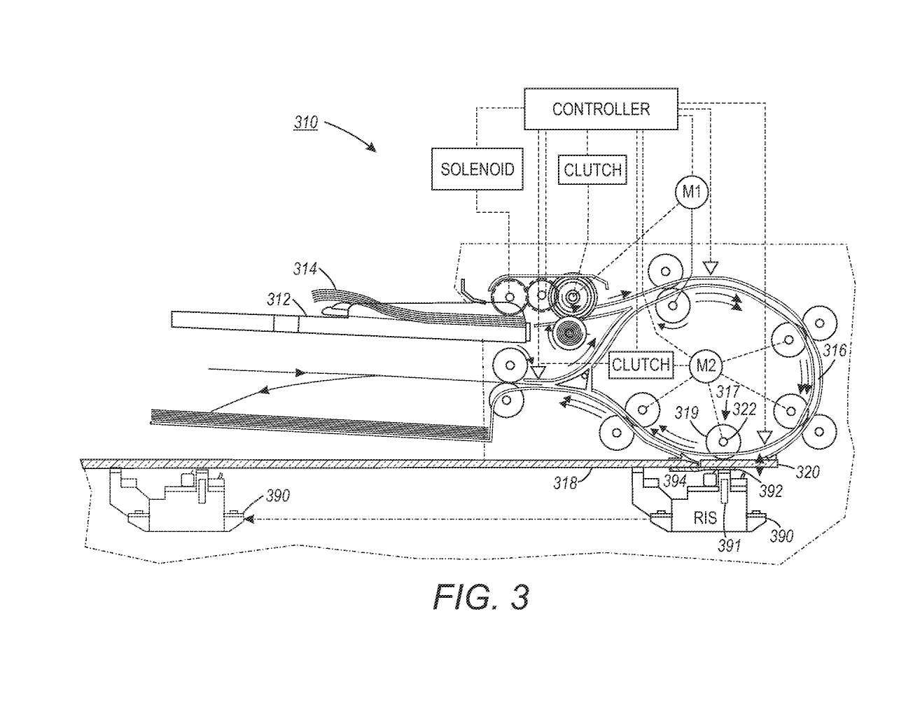

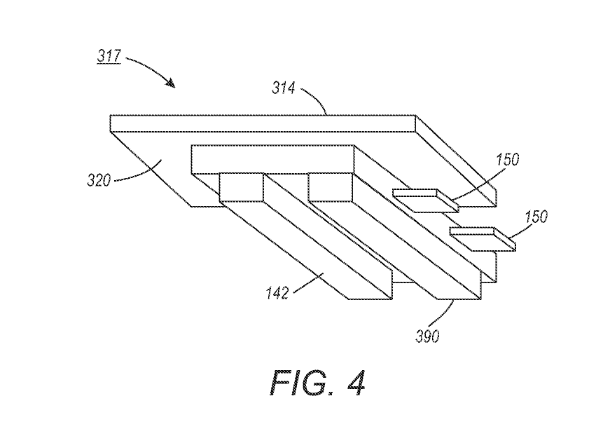

FIG. 1 also illustrates a main platen 114 adjacent to a document handler 104. With this exemplary printing device, items can be placed directly on the main platen 114, or a stack of sheets may be placed within the document handler 104. When the document handler 104 is closed over the main platen 114, the document handler 104 passes the sheets over the main platen 114 (and potentially a secondary platen 320, as illustrated in FIGS. 3 and 4, discussed below). While the document handler 104 and the main platen 114 are illustrated as being parts of a printing device 100, those ordinarily skilled in the art would understand that items 104 and 114 could comprise a separate stand-alone scanning device.

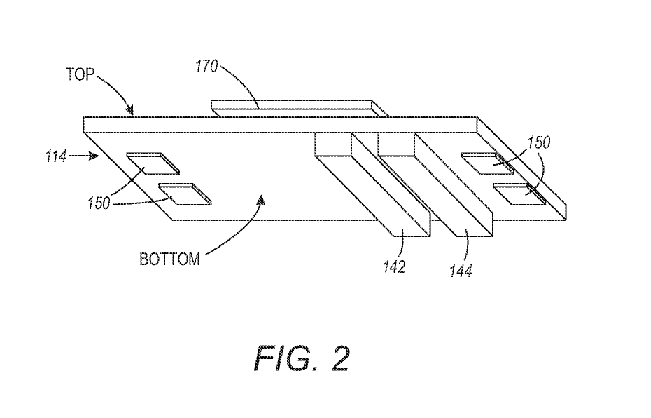

In any case, any of the scanning devices according to embodiments herein scan at lease one sheet of media using an optical scanner. Therefore, as shown in perspective view in FIG. 2 (from a direction internally within the printing or scanning device (from a direction below the bottom of the transparent scanning surface) a light producing device 142 (such as a light bar) shines light against an object to be scanned 170. The light reflected of the object 170 is detected by an optical scanner 144 (e.g., a scanner bar). In some embodiments herein, the light bar 142 and the optical scanner bar 144 can move beneath the transparent scanning surface 114 in order to scan the entire object 170. In other embodiments, the object 170 can be passed over the light bar 142 and the optical scanner 144 in order to scan the entire object 170.

The embodiments herein also include vibrating elements 150 (e.g., electro-mechanical elements and piezoelectric elements) connected to the transparent scanning surface 114. As is well-known to those ordinarily skilled in the art, electro-mechanical elements and piezoelectric elements may vibrate when supplied with a specific electrical charge (which may have a pattern) and the frequency at which such elements vibrate can be easily controlled. While the vibrating elements 150 are illustrated in the drawings as being located in specific positions, such elements 150 can be formed with (bonded within, molded within, etc.) or attached to (glued on, bonded to molded on, etc.) almost any location on the transparent scanning surface 114 (top, sides, bottom, frame attachment points, etc.) or any supporting structures.

The vibrating elements 150 can vibrate at frequencies that affect (move) debris particles on the transparent scanning surface, to thereby remove debris particles (shaking the debris particles) from the transparent scanning surface. The specific frequency produced by the vibrating elements 150 will be different for different applications. For example, different sized debris particles will be affected differently by different vibrational frequencies. Therefore, for each specific application, the frequency is (or multiple frequencies are) chosen to cause the most movement of the debris size particles that are most commonly found to contaminate a given scanning device.

Therefore, different scanning devices will utilize different vibrational frequencies in order to provide the self-cleaning feature of the embodiments herein. In addition, the embodiments herein can sequentially produce a number of different frequencies in each cleaning routine or cycle (applied, for example, randomly or in a specific pattern such as going from high frequency to low-frequency or low frequency to high-frequency) using the vibrating elements 150 so as to move particles of many different sizes from the transparent scanning surface, thereby increasing the self-cleaning efficiency.

While FIG. 2 illustrates one type of document handler 104 and platen 114 arrangement, FIGS. 3 and 4 illustrate a full width array (FWA) constant velocity transport (CVT) scanner/document handler, which is similar to the automatic document feeders disclosed in, for example, U.S. Pat. Nos. 5,339,139 and 6,593,995, the complete disclosures of which are incorporated herein by reference.

More specifically, in FIGS. 3 and 4 document sheets 314 to be imaged while moving may be automatically individually fed from a stack of sheets in an input tray 312 by a document feeder into a sheet path 316 to the CVT imaging station 317. At the imaging station 317, a CVT transport roller 319 engages and feeds the sheet 314 at a constant velocity while pressing the imaged area of the sheet 314 against the upper surface of the small (narrow) transparent glass imaging platen 320 to permit scanning by the raster input scanner (RIS) imaging optics unit 390. The RIS is part of a known type of imaging unit 390 having slide pads 392 providing a low friction surface. The structure also includes an imager bar 391, which may be a conventionally, commercially available, full document width array of multiple charge coupled device (CCD) raster input scanner (RIS).

Similarly, the structure includes transitioning strips 394 of flexible and relatively low friction material to the bottom side of platens, inboard and outboard, outside of the imaging station area. These slide pads 392 are biased to maintain engagement with the bottom surface of the platen 320, to thus maintain a consistent focal distance from the upper surface of the (floating) platen 320, and hence from the document 314 being imaged.

Although a single roll 319 (or common axis plural rolls) CVT is shown, it will be appreciated that there are other known CVT systems in which there is a pair of CVT rolls spaced on opposite sides of the imaging area 317 and a floating baffle holds the document down against the platen in imaging area.

When scanning a stationary item, the large platen 318 is used. This scanning is performed by the same single optics unit 390 and its slide pads 392 moving under that main platen 318, as shown by the movement arrow and phantom line position thereof. For each return to the first mode of automatic document feeding and scanning, the optics unit 390 must then return back to its imaging station 317 position.

Thus, similar to the structure shown in FIG. 2, in FIGS. 3 and 4, a transparent scanning surface (e.g., platen) 320 is positioned adjacent a sheet feeder. The sheet feeder supplies the sheets of media 314 to the transparent scanning surface 320 and moves the sheets of media across the transparent scanning surface 320. As was done in FIG. 2, FIG. 4 is also shown from below the transparent scanning surface 320. As shown in FIG. 4, the transparent scanning surface 320 also includes the vibrating elements 150 that are utilized to remove the various debris particles from the transparent scanning surface 320.

The controller 124 is operatively connected to the optical scanner 144, 390 and the vibrating elements 150. In some embodiments the controller can cause the vibrating elements 150 to vibrate after a predetermined number of sheets have passed over the transparent scanning surface, when the controller determines the transparent scanning surface is contaminated with debris (based on the quality of scans obtained by the optical scanner), and/or upon user request, etc. The vibrating elements 150 can alternatively vibrate at frequencies that cause pressure waves that move air particles over the transparent scanning surface.

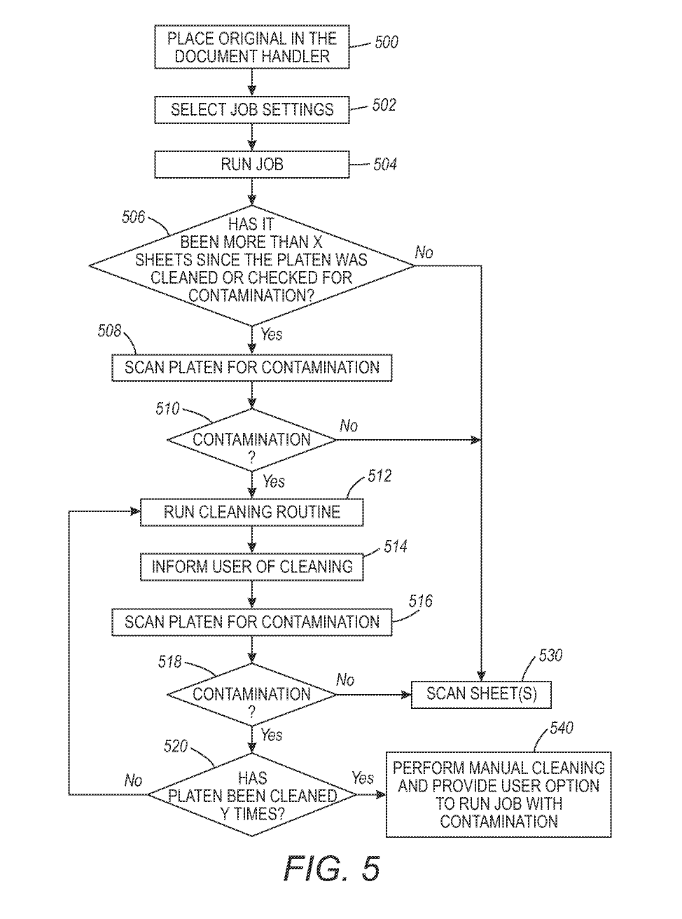

Various method embodiments herein move sheets of media using a sheet feeder of a scanning device, and one such exemplary method is shown in FIG. 5. As shown in item 500, one or more previously printed sheets can be placed in the document handler. Then, the various job settings are selected in item 502.

In item 504, the job is “run” to begin the scan cycle. However, before scanning is actually commenced, in item 506, this exemplary method determines whether there have been more than a certain predetermined number (X) of sheets that have been scanned since the platen was last cleaned or checked for contamination. Thus, every time a document is scanned, the controller stores increments a variable. If the predetermined sheet number is not exceeded, processing proceeds to scanning, as shown in item 530. When performing the scan in item 530, the method embodiments herein detect contrasting markings on the sheets of media through the transparent scanning surface using the optical scanner of the scanning device, as discussed above.

However, if the predetermined number of sheets is exceeded in item 506, processing proceeds to item 508 where a test scan is performed (a scan performed without a sheet of media on the transparent scanning surface) to find whether the transparent scanning surface has debris particles thereon.

Thus, once the variable X reaches the pre-determined value (default value or one set by a system administrator) prior to the document being scanned, a blank scan of the CVT roll is taken and analyzed by the controller for possible marks indicating CVT contamination. The contamination determination in item 510 (and item 518 below) can be based on any desired particle measure, such as a certain quantity of particles, a certain transparency measure, or a percentage of debris particles that is or is not acceptable, etc.

In item 510, if there are not debris contamination particles, processing proceeds to item 530 where the scan is commenced. Alternatively, processing proceeds to item 512 where a self-cleaning routine is performed by vibrating the vibrating elements 150 that are attached to the transparent scanning surface, as discussed above. Thus, if there is evidence of contamination, the system would attempt to remove this contamination (using the piezoelectric elements) prior to scanning the document.

In item 514, the process informs the user that the transparent scanning surface is being self-cleaned. After the vibrating elements 150 have performed the self-cleaning process, the transparent scanning surface is again subjected to a test scan (a second test scan) to determine whether the self-cleaning routine 512 was effective. If it was effective, processing proceeds to item 530 where the scan is commenced. Thus, following the cleaning routine a further blank scan of the CVT is taken to determine if the contamination has been cleared. If so the document is scanned.

However, if there is still evidence of contamination, the piezoelectric cleaning routine would be run again and repeated for “Y” cycles as determined by a default setting or a systems administrator. Thus, if the self-cleaning routine in item 512 did not remove the contamination, processing proceeds to item 520 to determine whether the self-cleaning routine 512 has been performed a certain predetermined number (Y) times. If the self-cleaning routine in item 512 has not been performed the predetermined number of times, it is repeated as shown by the arrow returning to item 512.

If after “Y” cycles the contamination is still present, a pop up screen will appear on the GUI 106 informing the user of potential contamination and providing the user an option to scan if they wish to continue with their job, or alternatively to make a service call. Thus, as shown in FIG. 5, if the self-cleaning routine in item 512 has been performed the predetermined number of times, and there is still contamination on the transparent scanning surface (as determined by item 518) processing proceeds to item 540 where the user is instructed to have a service technician perform a manual cleaning of the transparent scanning surface (through the GUI 106). In addition, in item 540, the user can be provided with an option of performing the scan on the contaminated transparent scanning surface (through the GUI 106).

Thus, the embodiments herein provide an automated cleaning routine so that users are not impacted by contamination. With the embodiments herein, the system automatically detects the contamination prior to the user running the scan. This reduces the number of scan quality complaints and service calls made because of debris contamination located on the underside of the CVT glass.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements).

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

What is claimed is:

1. A scanning device comprising:
a sheet feeder moving sheets of media;
a transparent scanning surface positioned adjacent said sheet feeder, said sheet feeder supplying said sheets of media to said transparent scanning surface;
an optical scanner positioned adjacent said transparent scanning surface, said optical scanner detecting contrasting markings on said sheets of media through said transparent scanning surface; and
vibrating elements connected to said transparent scanning surface.

2. The scanning device according to claim 1, said vibrating elements vibrating at frequencies that affect debris particles on said transparent scanning surface and that move debris particles from said transparent scanning surface.

3. The scanning device according to claim 1, said vibrating elements vibrating at frequencies that cause pressure waves that move air particles over said transparent scanning surface.

4. The scanning device according to claim 1, further comprising a controller operatively connected to said sheet feeder, said controller counting a number of sheets scanned by said scanning device.

5. The scanning device according to claim 1, said vibrating elements comprising one of electro-mechanical elements and piezoelectric elements.

6. A scanning device comprising:
a sheet feeder moving sheets of media;
a transparent scanning surface positioned adjacent said sheet feeder, said sheet feeder supplying said sheets of media to said transparent scanning surface;
an optical scanner positioned adjacent said transparent scanning surface, said optical scanner detecting contrasting markings on said sheets of media through said transparent scanning surface;
vibrating elements connected to said transparent scanning surface; and
a controller operatively connected to said optical scanner and said vibrating elements, said controller causing said vibrating elements to vibrate one of:
after a predetermined number of sheets have passed over said transparent scanning surface;
when said controller determines said transparent scanning surface is contaminated with debris based on quality of images obtained by said optical scanner; and
upon user request.

7. The scanning device according to claim 6, said vibrating elements vibrating at frequencies that affect debris particles on said transparent scanning surface and that move debris particles from said transparent scanning surface.

8. The scanning device according to claim 6, said vibrating elements vibrating at frequencies that cause pressure waves that move air particles over said transparent scanning surface.

9. The scanning device according to claim 6, said controller counting a number of sheets scanned by said scanning device.

10. The scanning device according to claim 6, said vibrating elements comprising one of electro-mechanical elements and piezoelectric elements.

11. A multi-function printing device comprising:
at least one printing engine;
at least one media path adjacent said printing engine, said media path supplying sheets of blank media to said printing engine;
a sheet feeder moving sheets of input media;
a transparent scanning surface positioned adjacent said sheet feeder, said sheet feeder supplying said sheets of input media to said transparent scanning surface;
an optical scanner positioned adjacent said transparent scanning surface, said optical scanner detecting contrasting markings on said sheets of input media through said transparent scanning surface;
vibrating elements connected to said transparent scanning surface; and
a controller operatively connected to said optical scanner and said printing engine,
said printing engine printing markings on said sheets of blank media corresponding to said contrasting markings detected on said sheets of input media by said optical scanner.

12. The multi-function printing device according to claim 11, said vibrating elements vibrating at frequencies that affect debris particles on said transparent scanning surface and that move debris particles from said transparent scanning surface.

13. The multi-function printing device according to claim 11, said vibrating elements vibrating at frequencies that cause pressure waves that move air particles over said transparent scanning surface.

14. The multi-function printing device according to claim 11, said controller counting a number of sheets scanned by said scanning device.

15. The multi-function printing device according to claim 11, said vibrating elements comprising one of electro-mechanical elements and piezoelectric elements.

16. A method comprising:
moving sheets of media using a sheet feeder of a scanning device, said sheet feeder moving said sheets of media across a transparent scanning surface of said scanning device;
detecting contrasting markings on said sheets of media through said transparent scanning surface using an optical scanner of said scanning device;
vibrating elements connected to said transparent scanning surface; and
causing, using a controller, said elements to vibrate one of:
after a predetermined number of sheets have passed over said transparent scanning surface;
when said controller determines said transparent scanning surface is contaminated with debris based on quality of images obtained by said optical scanner; and
upon user request.

17. The method according to claim 16, said vibrating comprising vibrating said elements at frequencies that affect debris particles on said transparent scanning surface and that move debris particles from said transparent scanning surface.

18. The method according to claim 16, said vibrating comprising vibrating said elements at frequencies that cause pressure waves and move air particles over said transparent scanning surface.

19. The method according to claim 16, further comprising counting a number of sheets scanned by said scanning device.

20. The method according to claim 16, said elements comprising one of electro-mechanical elements and piezoelectric elements.
